(19) United States
(12) Patent Application Publication
(10) Pub. No.: US 2014/0279403 A1
(43) Pub. Date: Sep. 18, 2014

(54) METHODS AND SYSTEMS FOR EXECUTING MOBILE CURRENCY TRANSACTIONS

(71) Applicant: Independence Bancshares, Inc., Greenville, SC (US)

(72) Inventors: Gordon BAIRD, Darien, CT (US); Humphrey CHEN, Palisades Park, NJ (US); Aditya KHURJEKAR, Basking Ridge, NJ (US)

(73) Assignee: Independence Bancshares, Inc., Greenville, SC (US)

(21) Appl. No.: 14/215,733

(22) Filed: Mar. 17, 2014

Related U.S. Application Data
(60) Provisional application No. 61/791,981, filed on Mar. 15, 2013.

(51) Int. Cl. G06Q 20/32

(52) U.S. Cl. CPC G06Q 20/322
USPC 705/38; 705/39; 705/44

(57) ABSTRACT

Exemplary embodiments provide methods, mediums, and systems for carrying out mobile transactions. An exemplary electronic currency message is provided for allowing currency messages to be passed in a secure manner between parties involved in a transaction, even when the networks used to pass the messages are insecure. The currency messages may be used by a transaction protocol that may pass the messages through middleware that allows for connections to multiple different external financial networks. The transaction protocol may create a credit cache on the user's mobile device and/or at the middleware to allow electronic currency transactions to be effected, even if the user's mobile device loses connectivity or power.

### RELATED APPLICATIONS

This application claims priority to U.S. Provisional Patent Application Ser. No. 61/791,981, entitled “Methods, Systems, and Mediums for Supporting Mobile Payments” and filed on Mar. 15, 2013. The contents of the aforementioned application are incorporated herein by reference

### BACKGROUND

Increasingly, consumers are relying upon computer networks, such as the Internet, as well as mobile devices, to engage in commerce. In conjunction with this trend, there has been a rise in the electronic movement of funds, as well as the use of electronic forms of currency. This has resulted in a number of problems and opportunities.

Regarding the electronic movement of funds, numerous banks provide online services. Similarly, some online services have begun to provide electronic access to funds. Typically, these entities make use of proprietary back-ends which process information related to the accounts of customers associated with the entity. However, there is no commonly-accepted middleware that allows the different back-ends of disparate entities to communicate with each other. This issue may make it difficult to fluidly move currency between entities, and for different entities to communicate with each other regarding a customer.

Regarding electronic forms of currency, some online services (e.g., PayPal™) provide a way to receive and transfer currency online. However, these online services suffer from limitations which may make it difficult for them to become widely adopted as a replacement for cash, credit cards, or other forms of currency. For example, these online services typically function similar to banks and therefore maintain records of transactions for a lengthy amount of time. Furthermore, some limitations of this form of service may prevent cash from being transferred from one entity to another quickly.

An additional concern with the electronic movement of funds and the use of electronic currency is that it may be difficult to verify the identity of the entity moving the funds or transferring the currency. Some entities may be subject to impersonation, making it extremely important to verify that a particular entity is who they say they are prior to authorizing a transfer of funds from the entity's account. Current authentication schemes may be cumbersome and/or prone to problems of impersonation (e.g., by stealing or guessing a user's password). Thus, there is a need for a secure and efficient electronic form of “identity” to ensure that an entity is who they purport to be.

Still further, the use of mobile devices and social networks to conduct commerce and interact with others on the Internet provides unique opportunities in such fields as authentication and the evaluation of creditworthiness. However, online services and banks currently do not take advantage of these opportunities.

The present application addresses solutions to these and other problems of electronic commerce and currency.

### SUMMARY

Exemplary embodiments provide methods, mediums, and systems for carrying out mobile transactions. An exemplary electronic currency message is provided for allowing currency messages to be passed in a secure manner between parties involved in a transaction, even when the networks used to pass the messages are insecure. The currency messages may be used by a transaction protocol that may pass the messages through middleware that allows for connections to multiple different external financial networks. The transaction protocol may create a credit cache on the user's mobile device and/or at the middleware to allow electronic currency transactions to be effected, even if the user's mobile device loses connectivity or power.

According to an exemplary embodiment, a middleware system may receive an electronic currency message relating to a transaction between a sender and a receiver. The middleware system may be programmed with interfaces for interfacing with one or more external transaction networks involved in the transaction. The electronic currency message may include an external package layer used by a network to transmit the electronic currency message and an encrypted security layer.

The middleware may decrypt the encrypted security layer to retrieve a transaction message comprising details related to the transaction. The middleware may identify the one or more external transaction networks involved in the transaction, and may connect to the one or more external transaction networks using the interfaces. Based on information from the external transaction networks, the middleware may cause the transaction to be effected. For example, the middleware may transmit an instruction to display a transaction code to the sender, wherein the transaction code is dynamically generated, at least in part, by the middleware. The transaction may be effected using a Bluetooth Low Energy (BLE) or Near Field Communications (NFC) protocol.

In some embodiments, the electronic currency message may identify a source of the transaction. The source may be authenticated with the one or more external transaction networks.

In some embodiments, the electronic currency message may identify a destination of the transaction. The destination may be authenticated with the one or more external transaction networks. Alternatively or in addition, the destination may be checked against a list of valid destinations that are authorized to engage in transactions with a sender of the electronic currency message. A transaction token may be sent to the destination and a sender of the electronic currency message.

In other embodiments, the electronic currency message may not identify a destination of the transaction.

According to another embodiment, credentials may be collected from a mobile device and a user of the mobile device. The collected credentials may be used to establish a creditworthiness of the user. For example, the creditworthiness of the user may be established, at least in part, based on the user's usage habits with respect to the mobile device and/or based on visitor location register (VLR) data obtained from the mobile device.

A credit structure comprising a representation of the creditworthiness of the user may be created and stored in a cache. Upon receiving a request to effect a transaction from the mobile device and identifying that the mobile device has lost power or connectivity, the credit structure stored in the cache may be queried to determine whether the user has sufficient credit to effect the transaction. The transaction may be effected if it is determined that the user has sufficient credit.

In some embodiments, the cache may be a local cache on the mobile device, and the mobile device may effect the transaction by consulting the credit structure stored in the local cache.

Alternatively or in addition, the cache may be a remote cache. For example, it may be determined that the mobile device is likely to imminently lose connectivity or power. The credit structure may be uploaded to middleware remote from the mobile device, and the cache may be created at the middleware. The request to effect the transaction may be received at the middleware, and the middleware may query the credit structure and effect the transaction.

According to another embodiment, a system may be provided including a push-to-pay entity, such as a hardware button on mobile device, and a processor. The processor may be programmed with instructions.

The processor may receive a request to effect a transaction from the push-to-pay entity, and collect information identifying the system, a user of the system, and the transaction. The processor may create a transaction message comprising the information identifying the system, the user of the system, and the transaction, and may encrypt the transaction message in an encrypted security layer. The processor may wrap the encrypted security layer in an external package layer to create an electronic currency message, wherein the external package layer is visible to a network.

The processor may transmit the electronic currency message via the network to middleware interfaced with one or more external transaction networks involved in the transaction, and may receive an instruction to effect the transaction from the middleware. Based on the received instruction, the processor may effect the transaction. For example, the processor may cause a transaction code, such as a QR code or bar code, to be transmitted to a destination of the transaction. The transaction may be effected via a Bluetooth Low Energy (BLE) or Near Field Communications (NFC) protocol.

The exemplary embodiments will be described in more detail with respect to the Figures discussed below.

### BRIEF DESCRIPTION OF THE DRAWINGS

FIG. 1 depicts an exemplary environment for conducting mobile transactions.

FIG. 2 depicts an exemplary format for an electronic currency message.

FIG. 3 depicts a flowchart describing an exemplary process for generating, transmitting, and receiving an electronic currency message.

FIG. 4 depicts a flowchart describing an exemplary process for offline performance of an electronic currency transaction.

FIG. 5 depicts an electronic device suitable for use with exemplary embodiments described herein.

### DETAILED DESCRIPTION

### Terms and General Notes

Unless otherwise noted, the following terms are used herein with the following meanings:

A typical environment involving the transfer of electronic currency (e.g., for micropayments) includes a Sender, e.g. the entity that provides the value (money, currency, funds or other tangible units of value); a Receiver, e.g. the entity that receives the value; a Sending Agent, e.g. the entity that facilitates the sending of value on behalf of the Sender; a Receiving Agent, e.g. the entity that facilitates the receiving of value on behalf of the Receiver; the Provider, e.g. the administrator of the Exchange, which may be a clearinghouse, marketplace, aggregator or overall facilitator of such a service. The Provider is often expected to be an authorized financial institution.

In the context of authentication and/or identification, the individual whose identity is being established (e.g., the primary user under consideration) is referred to as Subscriber, distinct from other users who may also be part of the method or system. The established identity is referred to herein as an mIdentity. The establishment of an mIdentity may begin when a user attempts to initiate a relationship or a transaction that is enabled or managed by an authorized financial institution (which may be a Provider), even though the account or transaction may be distributed by another entity (a Beneficiary of an mIdentity). The Provider may be typically a bank, while the Beneficiary can be any business entity or individual who needs to establish the mIdentity of Subscriber. Other entities who may provide information that creates or modifies mIdentity, as managed by the Provider, will be referred to as a Source or Sources.

As used herein, an Open Loop Network is a multi-party network that connects two or more financial institutions for carrying out financial transactions. Payments for goods and services in an open loop network are typically managed by the connected financial institutions (usually a first financial institution that issues credit to a customer, and a second financial institution that is associated with a merchant). Visa and MasterCard are examples of open loop networks. In contrast, a Closed Loop Network is a network in which payments are made directly by the owner of the network (e.g., a merchant that issues a private-label credit card to its customers, or a merchant that issues a specialized currency such as Disney Dollars).

As used herein, micropayments are financial transactions, usually of small value, between many distinct senders and receivers, and usually large in number and with a high frequency of occurrence.

As used herein, a currency may be a physical currency, a currency issued by a state entity, and/or a virtual currency such as BitCoin.

Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of an electronic device, unless otherwise stated.

No element, act, or instruction used in the description of the invention should be construed critical or essential to the invention unless explicitly described as such. It is intended that the invention not be limited to the particular embodiments disclosed above, but that the invention will include any and all particular embodiments and equivalents falling within the scope of the description herein.

### Contextual Material

As noted above, exemplary embodiments described herein relate to mobile transactions. In some embodiments, these mobile transactions may be used in conjunction with mobile currency messages and mobile currency message routing protocols. Examples of processes and systems for managing mobile currency messages are described in U.S. patent application Ser. No. 14/212,556 entitled Mobile Currency Messaging Systems (attorney docket no. IBW-001), filed Mar. 14, 2014. The contents of this application are incorporated herein by reference.

Furthermore, some embodiments may be used in conjunction with mobile identities and authentication techniques—for example, in order to verify the identities of parties to a mobile transaction. Examples of mobile identities and authentication techniques are described in U.S. patent application Ser. No. ______ entitled Creation and Use of Mobile Identities (attorney docket no. IBW-002), filed Mar. 17, 2014. The contents of this application are incorporated herein by reference.

### Exemplary Embodiments

Exemplary embodiments may be practiced in an environment including a sender that sends value (such as electronic currency) to a receiver of the value in a transaction, and various entities that facilitate or process the transaction. An example of such an environment is depicted in FIG. 1.

The sender 110 may effect the transaction through a mobile device 120. The mobile device 120 may include an application, such as a mobile financial application or mobile wallet, that allows the sender 110 to effect a financial transaction. The financial transaction may be, for example, a request to send value to a receiver 130.

The receiver 130 may be another user of the mobile financial application, or may be a third party. The receiver 130 may receive the value on the receiver's mobile device.

Both the sender 110 and the receiver 130 may be located in a closed loop network 140, and the mobile financial application may be a custom application dedicated to servicing transactions in the closed loop network 140. Alternatively, one or neither of the sender 110 and receiver 130 may be in the closed loop network 140, or the sender 110 and receiver 140 may be in different closed loop networks.

The transaction may make use of an external transaction network 150. The external transaction network 150 may be, for example, a bank at which the sender 110 and/or receiver 130 has an account. In one example, the sender 110 may wish to draw funds from their account with the external transaction network 150 and transfer the funds to the receiver 130 (or vice versa)

Multiple external transaction networks 150 exist, but conventionally may have difficulty communicating with each other (e.g., due to technological insufficiencies). To facilitate the connection of the sender 110 and the receiver 130 to an external transaction network 150 and/or to each other, and to facilitate connections between different external financial networks 150, middleware 160 may be provided. The middleware 160 may serve as a point of contact with the entities involved in a transaction, and may be programmed with logic for processing messages and requests related to the transactions. FIGS. 3 and 4 describe exemplary logic which may be employed by the middleware 160 in more detail.

The sender 110 and the receiver 130 need not necessarily interact with external transaction networks 150 in order to effect a transaction. In some embodiments, the sender 110 and the receiver 130 may interact directly with each other, either through a direct connection 170 (e.g., facilitated by a mobile financial application on the mobile device 120 and at the receiver 130), or through an indirect connection through the middleware 160.

If the sender 110 is attempting to interact with a receiver 130 in a closed loop network 140 (e.g., the sender 110 is attempting to conduct a transaction within the closed-loop network), exemplary embodiments described herein allow the sender 110 to add their mobile device to the closed loop network, in addition to any other interaction methods otherwise supported by the closed-loop network.

Conventionally, select amusement parks, mass transit systems, hotels, casinos and cruise ships, etc. allow for legal tender to be deposited into their closed loop payment system, and to make payments via bar code, RFID bracelets smartcards, etc. Some examples of closed loop payment systems are those employed by Walt Disney Cruise ships, New York City Mass Transit Authority (MTA), Caesar's Palace, and Hyatt Hotels.

According to exemplary embodiments, protocols and interfaces may be provided for effecting a closed loop payment through the user's mobile device without the need to (for example) download an application specific to the closed loop network 140. The identify of closed loop network 140 may be determined, e.g., by user selection or by querying a payment system of the closed loop network 140. The above-mentioned protocols and/or interfaces may be consulted to generate a payment tender that is compatible with the closed loop network 140 (e.g., by generating a bar code or QR code that can be read by the closed loop network 140's payment system). In some circumstances, existing point of sale/turnstiles may be retrofitted to allow for the mobile/smart phone to be utilized to represent payments in the closed loop. In other circumstances, the user's mobile device may be capable of generating a payment tender that is understandable by the closed loop's point of sale.

When the sender 110 and receiver 130 conduct a transaction, one or more transaction messages may be generated and sent between entities involved in the transaction. Problematically, some of the connections between entities (e.g., between the sender 110 and the middleware 160) may be public connections and may therefore be vulnerable to malicious actors. In order to protect the details of the transaction, a secure electronic currency message (e.g., a specialized data packet) may be generated and sent on the network. FIG. 2 depicts an exemplary format for an electronic currency message 200.

The electronic currency message 210 may include an external package layer 210. The external package layer 210 may be the layer of the message that is visible and understandable to the protocol used by the network transmitting the message (e.g., if the network transmitting the message is a TCP/IP network, the external package layer 210 may resemble a TCP/IP packet).

The external package layer 210 may be encrypted, if the protocol associated with the external package layer 210 supports encryption. However, it may not be possible to guarantee that the protocol will securely transmit the electronic currency message 200. Accordingly, an encrypted security layer 220 may be provided as a payload within the external package layer 210.

The encrypted security layer 220 may include an encryption key, such as a static encryption key. An entity receiving the electronic currency message 200 may require a matching key and details of the encryption protocol used to encrypt the encrypted security layer 220 in order to decrypt the encrypted security layer 220. Accordingly, even if the electronic currency message 200 is sent on an otherwise unsecured network, the encrypted security layer 220 may provide a level of protection for the electronic currency message 200. In some embodiments, the encryption key and/or details of the encryption protocol may be dynamically generated in order to protect the integrity of the electronic messaging system.

Within the encrypted security layer 220, a transaction message 230 may include details of the transaction. For example, the transaction message 230 may include a field specifying a device identifier 232 (e.g., representing an identifier, such as a serial number or code number, for the mobile device that originated the electronic currency message 200). The transaction message 230 may also specify a user identifier 234 representing an identity of a user associated with the electronic currency message 200 (e.g., the sender 110 that requested a transfer of funds which is represented by the transaction message 230).

The transaction message 230 may further include a time stamp 236 and an expiration time or duration 238. The expiration time or duration 238 may represent a period of time or and ending time for which the transaction represented by the electronic currency message 200 is valid. Upon receiving the electronic currency message 200, the receiver may evaluate the time stamp 236 and the expiration time 238 against the current time in order to determine whether the transaction remains valid. If so, the receiver may enact the transaction. If not, an error message may be generated and returned to the sender (e.g., “TRANSACTION_EXPIRED”).

The transaction message 230 may further include an indication of geolocation eligibility 240. The geolocation eligibility indicator 240 may specify the location at which the transaction originated (e.g., latitude and longitude coordinates). This location may be checked against a “geographical fence” associated with the user identifier 234, which indicates locations from which the user is authorized to conduct transactions. For example, if the user's geographical fence extends 200 miles from their home location, but the geolocation information in the geolocation eligibility indicator 240 indicates that the current transaction originated 1,000 miles away from the user's home, then the transaction may be disallowed and flagged as a potential fraud.

The transaction message 230 may further identify an amount and a type of currency 242 that is to be transferred. The currency may be a government-issued currency (e.g., US Dollars, British Pounds, etc.) or may be a virtual currency (e.g., BitCoin), among other possibilities. The currency type and amount 242 may also indicate a direction of transfer. For example, if the sender is attempting to send money to the receiver, then the currency type and amount 242 may be a positive number. If, on the other hand, the sender is requesting payment from the receiver, then the currency type and amount 242 may be a negative number.

An identifying key 244 may identify the transaction related to the transaction message 230. If multiple electronic currency messages 200 are issued pertaining to a single transaction, the identifying key 244 may be the same for each message. Alternatively, each portion of the transaction may be assigned a different identifying key 244. The identifying key 244 may allow the transaction details to be indexed and/or recalled in the future (e.g., in case of audit, in order to purge the transaction details, or to serve as a receipt in case the sender later wishes to verify the transaction).

The transaction message 230 may also be tagged with a compliance code 246. The compliance code 246 may identify relevant regulatory information (e.g., to flag the transaction message 230 as being of a particular regulatory class or type).

The exemplary electronic currency message 200 of FIG. 2 may be used in connection with an electronic transaction protocol (e.g., electronic currency messages 200 may be passed between the sender, middleware, and receiver in an electronic transaction). An exemplary electronic transaction protocol is depicted in the flowchart of FIG. 3.

A step 310, a payment request may be received. In some embodiments, the payment request may be generated by a mobile financial application on the sender's mobile device and may be sent to the middleware. The payment request may be transmitted via a transmission scheme, such as WiFi, Bluetooth Low Energy (BLE), Near Field Communications (NFC), or any other suitable transmission scheme. The payment request may be in the form of an electronic currency message 200, and details of the transaction may be retrieved from the electronic currency message 200.

Optionally, the payment request may be generated in response to the activation of “push-to-pay” functionality on a mobile device. Push-to-pay functionality may simplify the process of conducting a financial transaction.

Current systems that allow a consumer to conduct financial transactions on a mobile device require many steps on part of the user to actually complete the transaction. The steps may involve downloading an application from a marketplace, locating the application on the device, configuring the application, entering a username and/or password and confirming the transaction with further interactive responses.

Exemplary embodiments of the “push-to-pay” functionality reduce the number of steps in conducting a financial transaction on a connected mobile device to a single action. This may involve pushing a mechanical or dedicated, soft, on-screen button. Accordingly, exemplary embodiments provide an intuitive mobile payment experience for the user, and eliminate the friction in completing a mobile payment transaction on a connected device.

Push-to-Pay functionality on a mobile device, such as a phone, smart phone, tablet or other similar portable form factor, may be implemented in various ways.

A mechanical button may be provided, placed conveniently on the device for easy access, yet protected from involuntary activation. Alternatively, a dedicated icon on the default or home screen of the device may be provided. Activating the dedicated icon may mimic the functionality of an actual mechanical button. Still further, a virtual button, activated by voice, gesture, or other non-tactile input into the mobile device, may be employed.

Push-to-Pay functionality may be provided to another application, program or functionality on the device, which may benefit from a single action system to provide a financial transaction service to the user. Such association may be implemented via an API that is utilized in the creation of the third party application itself, or it can be provided to the application or service provider on-demand, in real time, based on user configuration.

Upon activating the push-to-pay functionality, a graphical interface may be provided allowing the user to specify an amount of value to be transferred, and a recipient to whom the value should be transferred. Alternatively, as described in more detail below, in some embodiments no recipient needs to be specified. In this case, after evaluating whether or not the user has the necessary funds available, the middleware may cause the mobile device to display a code (such as a bar code or QR code) or transmit a signal (such as a BLE or NFC signal) that may transfer the requested value to a nearby mobile device. This may allow a mobile transaction to mimic the simplicity and efficiency of a cash transaction.

Based on information obtained from the interface and/or pre-stored information, the mobile device may generate an electronic currency message and forward the message to the middleware.

At step 312, the entity receiving the payment request (e.g., the middleware) may connect to a payments network 312. The payments network 312 may represent a financial institution at which the sender and/or receiver has an account, such as a bank from which the sender wishes to transfer funds.

The payments network 312 may be identified based on information in the electronic currency message or based on outside information. For example, the middleware may retrieve an identity of the payments network from the electronic currency message, or may look up the sender in a local database to determine a preferred payments network associated with the sender.

The middleware may be programmed with interfaces, APIs, or protocols allowing the middleware to access and make requests to the payments network. Upon determining which payments network to access, the middleware may connect to the payments network using the compatible interfaces, APIs, or protocols.

During step 312 (and/or elsewhere during the process depicted in FIG. 3), the transaction may acquire FDIC insured status due to the FDIC status of the middleware and/or external payments network 312.

At step 314, the middleware may evaluate the payment request to determine whether a destination of the payment has been specified. In some embodiments, the payment request need not specify a destination. In such a circumstance, the payment request may be interpreted as a request to access funds associated with the sender's account for performing a local transaction in the vicinity of the sender's mobile device (e.g., the sender wishes to use their account with the Starbucks Closed-Loop Network in order to make a payment with their mobile device at a Starbucks). If the determination at step 314 is “NO” (i.e., no destination has been identified, indicating a local transaction), then processing may proceed to step 316.

At step 316, the source may be authenticated to determine whether the transaction is valid. For example, the middleware may contact the payments network and verify that the information contained in the electronic currency message matches the sender's credentials. Once the source is authenticated, processing may proceed to step 318.

At step 318, a transaction code may be displayed. The transaction code may take the form of (for example) a Quick Response (QR) code, a bar code, or a dynamically generated string. The transaction code may be dynamically generated, at least in part, by the middleware. For example, the transaction code may be generated in part on the basis of information retrieved from the external network. When the transaction code is scanned or otherwise input at the payment destination, the transaction may be effected.

Processing may then proceed to step 320 and terminate.

Steps 314-318 describe a local transaction for which a destination was not identified. If, on the other hand, the determination at step 314 is “YES” (indicating that a destination for the value was identified in the payment request), then processing may optionally proceed to step 322.

At step 322, the middleware may check the destination indicated in the payment request against a list of valid destinations. The list of valid destinations may include a list of eligible receivers that the sender has previously indicated are authorized to receive value from the receiver (e.g., the list of valid destinations may include a list of closed loop networks which are authorized to receive payments from the sender, a list of merchants with which the receiver does business, etc.). Providing such a list may allow the sender to reduce the chances of fraud in performing electronic transactions.

If the destination in the payment request does not match any of the authorized destinations in the valid destination list, then processing may proceed to step 324 where a termination message may be sent. The termination message may be displayed on the sender's mobile device and may indicate why the transaction failed (e.g., “ERR_UNAUTHORIZED_RECEIVER”). Optionally, the transaction may be flagged as being potentially fraudulent. Processing may then proceed to step 320 and terminate.

If the destination in the payment request does match an authorized destination in the valid destination list, then processing may proceed to step 326. If no list of valid destinations exists, processing may skip step 322 and proceed directly from step 314 to step 326.

At step 326, the middleware may authenticate both the source and the specified destination. For example, the middleware may connect to a back-end authentication server of the payments network of the sender (and potentially another payments network associated with the destination of the value, if different than the sender's payments network) and provide the credentials of the sender and receiver. Thus, the middleware may verify that both the sender and the receiver are allowed to access the funds related to the transaction.

The credentials used to authenticate the sender and receiver may be obtained from the electronic currency message, pre-stored information with the middleware, or a combination of both. If any needed credentials are not present or retrievable, then the middleware may request the credentials from the sender or the receiver, e.g. by presenting a graphical interface on the sender's or receiver's mobile device for supplying the credentials.

Once the sender and receiver have been authenticated, the middleware may return a transaction token to the source and destination. The transaction token may serve to validate the sender and receiver by the middleware (which may act as a trusted validation agent) so that the sender and receiver may make direct contact with each other and effect the transaction.

Accordingly, using the transaction tokens obtained at step 328, the source may attempt to establish a connection directly to the destination using the transaction token. The destination may receive a request to establish the connection, and may evaluate the sender's transaction token against the transaction token provided to the receiver by the middleware. If the transaction tokens match, then the receiver may allow the connection to be established.

Alternatively, the middleware may effect the transaction by acting as an intermediary, without the source and destination needing to connect to each other directly.

As part of the connection process, the destination may be presented with details of the transaction and may be asked for confirmation that the destination wishes to effect the transaction. If the destination confirms that the transaction should go forward, then processing may proceed to step 332 where the transaction may be executed. This may involve having the middleware generate additional transaction messages and/or communicating with the external payments network in order to transfer the value from the sender to the receiver (or vice versa).

Optionally, records of the transaction may be automatically purged upon completion of the transaction (or shortly thereafter), as described in the aforementioned patent application entitled Mobile Currency Messaging Systems.

Processing may then proceed to step 320 and terminate.

One potential problem that may be encountered as an attempt is made to effect a transaction is that the sender's device may lose connectivity or power. For example, if the user initiates an electronic purchase with an online merchant, a closed loop network point of sale, or a nearby mobile device (e.g., through BLE or NFC), but loses connectivity or power before the transaction can be completed, then it may not be possible for the user's or recipient's device to receive information from the middleware that allows the transaction to be completed.

This may be particularly problematic because the user may be unaware whether the transaction was completed or not. Thus, the user may attempt to recreate the transaction, even if the transaction has already completed (and hence may be double-billed for the transaction).

In order to address this problem, a “credit cache” may be used to effect offline transactions. Exemplary embodiments provide techniques for determining the credit worthiness of an individual and the security of the individual's device, and extending credit while the device is “offline” or “powered down” in order to complete a transaction that was in process or that was initiated. The credit may be extended by an external financial network with which the user is affiliated (e.g., by prior agreement).

For example, consider an individual that had an authorized bank account at a bank. The individual attempts to engage in a transaction and loses their device's data connection. If the user has remained in the same general geographic location for a predetermined period of time (e.g., for 30 minutes after the device losing connection), and there was sufficient currency in the account prior to the device losing connection, then the credit limit being held in the cache on the device may permit transactions to occur using the device as a payment method. This may occur as long as the amount requested is not more than a predetermined threshold (e.g., 60%) of the currency that was in the account just prior to the loss of connection, and as long as the request is taking place no longer than the predetermined amount of time later than when the device lost the connection.

An exemplary method for creating and using a credit cache is depicted in the flowchart of FIG. 4.

At step 410, the credentials of a mobile user device may be established. For example, whether the device is on a secure connection, the quality of the connection, whether the device stores/transmits information in an encrypted format, etc. may be considered. This step may allow the credit offering to be better protected against fraud.

For example, a user's credit information (discussed in more detail with respect to step 420, below) may be combined with device authentication data and encryption processes similar to when a mobile device roams from cell tower to cell tower, and the device communicates back and forth with the network, the tower, and a switch. The device's VLR (visitor location register) and the HLR (home location register) may be accessed to maintain authentication of the device and the authorization to continue with the transaction being proposed by the payment application. This creates a very secure, encrypted authentication process and authorization protocol that ensures that the device is the only one allowed to make the payment (at the same quality standard as voice traffic over a wireless network). In other words, such a procedure provides a security level akin to that of a phone conversation, which is prevented from being accessed or “hacked” by another individual having a phone conversation in the same general location.

At step 420, the credentials of an individual and/or account associated with the individual may be calculated. For example, a credit worthiness for the individual/account may be calculated. As part of this step, there may be an “onboarding” and/or account set up process that initiates a credit assessment of the individual by using credit scores, address, income validation, and other traditional credit score and underwriting techniques.

An exemplary procedure for calculating an individual's credit worthiness, using data collected from a network-connected user device and individual activities, is provided below.

Historically, an individual's “credit score” was assessed by one of three major consumer credit rating agencies: Fair Isaac (the FICO score), Equifax, and TransUnion. The data generally used to calculate a person's credit score may include items such as historical payment history, delinquencies, defaults, amount of funded consumer debt, income levels, unused credit lines, bank accounts

Exemplary embodiments may utilize the above-described credit information, but augment this information with additional information obtained from the user device to determine a better predictor of fraud and credit worthiness.

The basic credit information identified above may be collected and combined with other information that may be correlated with credit worthiness In some embodiments, the other information may be obtained from the user's mobile device. Examples of other information include where the person is, what types of transactions the person is making, what the person's monthly phone bill is, what types of calls are made, where, at what times of day, and how long the individual is on the phone and with what types of other devices, how many failed connection has the user experienced in the past, how many different towers has the user connected to, what has been the strength of the user's signal been, what geographic regions or sub regions does the user frequent, a type of the user's mobile device (e.g., is the device expensive or inexpensive?), what types of apps the user has downloaded, how often the use upgrades their mobile device's operating system (which may be an indication of technological sophistication, which may correlate to a lower credit risk), whether the user's data usage peaks at certain times in a day or month, how often the user's phone is turned on and off, etc. In addition, in some embodiments information from social networks may be gathered and used in order to facilitate the determination of credit worthiness. Any or all of this information may provide information relevant to assessing the user's credit risk.

Over time, the collection and analysis of this data may be used to create a credit assessment and predictor for the individual. The consumer may “opt in” to allowing the measurement of certain information as part of an account sign-up and privacy agreement. The consumer may be given the option to purge the data, for example in the situation where the consumer decides to leave the service.

Once this information is evaluated at step 412, At step 414 a cache may be created on the user's mobile device. The cache may be a hardware memory cache (e.g., in an NFC chip or other chipset in the device) or a software cache. In the case of a software cache, the cache may be stored in memory or in an application or sub layer of the device's software.

At step 416, a credit structure, such as a file or other data structure, may be created and stored in the cache. Depending on the particular application and the specifics of the individual user, the credit structure may store account data for the user and other factors (e.g., geopositioning data). Using the credit structure, the device may establish a real time and constantly enabled credit limit and credit time-out period.

In some embodiments, the “creditworthiness” of the individual may be stored in a file representing a user's digitally-calculated identity (a “Digital Identity File,” or “DIF”). The aforementioned patent application entitled Creation and Use of Mobile Identities describes an exemplary DIF suitable for use with the presently-described credit cache.

At step 418, the user's mobile device may be monitored (or the user's mobile device may monitor itself) to determine whether there is a high likelihood (e.g., a likelihood above a predetermined threshold) of connectivity or power loss. For example, the battery of the user's mobile device may be evaluated to determine if it is low, and/or the rate at which the user is using battery power. The user's geographical location may be evaluated and checked against known location data to determine if there are obstacles (e.g. a tunnel) in the vicinity which might cause the user to loose connectivity. The user's signal strength may also be evaluated to determine if a connectivity loss is imminent.

If the answer at step 418 is “YES” (a connectivity loss may be imminent), then the user's mobile device may upload a copy of the credit structure to the middleware. Thus, if the user loses connectivity while attempting to complete the transaction, the middleware may access the information in the credit file to complete the transaction on behalf of the user.

At step 422, a transaction involving an electronic payment may be effected through the user's mobile device. The middleware may register that the transaction has commenced.

During the transaction, the primary data source of the device (e.g., a wireless network) may become inactive. Thus, at step 424, the middleware and/or the user's mobile device may determine whether a network connection is present.

If the answer at step 424 is “YES” (the connection is present), then processing may proceed to step 426 and the connection may be used to effect the transaction (as long as the other conditions of the transaction, such as the user having sufficient funds, are met).

If, on the other hand, it is determined at step 424 that the device's connection has been lost, the software that was attempting to effect the payment may reroute to the “cache credit file” to see if there is sufficient authorization to continue with the transaction. This software may be, for example, software on the user's mobile device (if the user was attempting to enact a local transaction, such as a local payment in a closed loop network) or the middleware in the case of a remote transaction. Thus, at step 426, it may be determined whether the user is attempting to carry out a local transaction.

If the answer at step 428 is “YES,” then processing may proceed to step 430 where local software resident on the user's mobile device (e.g., a mobile financial application such as a mobile wallet) may query the local credit structure to determine whether the user has enough offline credit to complete the transaction. This may include reading the credit file and characteristics, the type of proposed transaction and whether the requested amount exceeded the credit limit. The credit limit may be dynamic and adjusted as additional transactions were attempted. This activity may also be wrapped in an encryption process to ensure security and privacy.

If the answer at step 428 is “NO” (e.g., a remote transaction is being attempted), then at step 432 the middleware may evaluate its most recent copy of the user's credit structure (e.g., the copy uploaded at step 420) to determine whether the user has enough offline credit to complete the transaction.

If it is determined at either step 430 or 432 that the user has enough credit to complete the transaction, then processing may proceed to step 426, where the transaction may be effected. A record of the transaction may be uploaded to relevant entities when connectivity or power is restored at the user's mobile device.

In some embodiments, a geographical restriction may be in place for further security (e.g., transactions can only be effected within a certain predefined geographical range from where the device's connection was lost).

The “offline” process of steps 430-432 may also be replicated in a “powered down” situation for NFC or chip based transaction where a chip reader would be the device with power reading the credentials of the NFC device. Such a device may access the “credit file” to assess if a credit limit exists, and may use the credit limit to seek authorization to proceed with the transaction.

Thus, using the exemplary embodiments described herein, mobile transactions may be effected in a secure and efficient manner, even if the user's mobile device loses connectivity or power.

### Computer-Implemented Embodiments

Some or all of the exemplary embodiments described herein may be embodied as a method performed in an electronic device having a processor that carries out the steps of the method. Furthermore, some or all of the exemplary embodiments described herein may be embodied as a system including a memory for storing instructions and a processor that is configured to execute the instructions in order to carry out the functionality described herein.

Still further, one or more of the acts described herein may be encoded as computer-executable instructions executable by processing logic. The computer-executable instructions may be stored on one or more non-transitory computer readable media. One or more of the above acts described herein may be performed in a suitably-programmed electronic device.

An exemplary electronic device 500 is depicted in FIG. 5. The electronic device 500 may take many forms, including but not limited to a computer, workstation, server, network computer, quantum computer, optical computer, Internet appliance, mobile device, a pager, a tablet computer, a smart sensor, application specific processing device, etc.

The electronic device 500 described herein is illustrative and may take other forms. For example, an alternative implementation of the electronic device may have fewer components, more components, or components that are in a configuration that differs from the configuration described below. The components described below may be implemented using hardware based logic, software based logic and/or logic that is a combination of hardware and software based logic (e.g., hybrid logic); therefore, components described herein are not limited to a specific type of logic.

The electronic device 500 may include a processor 502. The processor 502 may include hardware based logic or a combination of hardware based logic and software to execute instructions on behalf of the electronic device 500. The processor 502 may include one or more cores 503 that execute instructions on behalf of the processor 502. The processor 502 may include logic that may interpret, execute, and/or otherwise process information contained in, for example, a memory 504. The information may include computer-executable instructions and/or data that may implement one or more embodiments of the invention. The processor 502 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. The processor 502 may include a single core or multiple cores. Moreover, the processor may include a system-on-chip (SoC) or system-in-package (SiP).

The electronic device 500 may include a memory 504, which may be embodied as one or more tangible non-transitory computer-readable storage media for storing one or more computer-executable instructions or software that may implement one or more embodiments of the invention. The memory 504 may comprise a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

The electronic device 500 may include a virtual machine (VM) 505 for executing the instructions loaded in the memory 504. A virtual machine 505 may be provided to handle a process running on multiple processors 502 so that the process 502 may appear to be using only one computing resource rather than multiple computing resources. Virtualization may be employed in the electronic device 500 so that infrastructure and resources in the electronic device 500 may be shared dynamically. Multiple VMs 505 may be resident on a single electronic device 500.

A hardware accelerator, 506 may be implemented in an ASIC, FPGA, or some other device. The hardware accelerator 506 may be used to reduce the general processing time of the electronic device 500.

The electronic device 500 may include a network interface 508 to interface to a Local Area Network (LAN), Wide Area Network (WAN) or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 508 may include a built-in network adapter, network interface card, personal computer memory card international association (PCMCIA) network card, card bus network adapter, wireless network adapter, universal serial bus (USB) network adapter, modem or any other device suitable for interfacing the electronic device to any type of network capable of communication and performing the operations described herein.

The electronic device 500 may include one or more input devices 510, such as a keyboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 500 may include other suitable I/O peripherals.

The input devices 510 may allow a user to provide input that is registered on a visual display device 514. A graphical user interface (GUI) 516 may be shown on the display device 514.

A storage device 518 may also be associated with the electronic device 500. The storage device 518 may be accessible to the processor 502 via an I/O bus. Information stored in the storage 518 may be executed, interpreted, manipulated, and/or otherwise processed by the processor. The storage device 518 may include, for example, a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the invention

The storage device 518 may further store files 420, applications 522, and the electronic device 500 can be running an operating system (OS) 524. Examples of OS may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile electronic devices, or other operating system capable of running on the electronic device 500 and performing the operations described herein. The operating system 524 may be running in native mode or emulated mode.

The storage device may further store logic 526 for generating electronic currency messages, push-to-pay logic 528 for initiating a transaction, a credit structure 530, an electronic currency message 100, and any other logic suitable for carrying out the procedures described in the present application.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

1. An electronic-device implemented method for using an electronic currency message, the method comprising:
receiving, at a middleware system, an electronic currency message relating to a transaction between a sender and a receiver, wherein the middleware system is programmed with interfaces for interfacing with one or more external transaction networks involved in the transaction and the electronic currency message comprises an external package layer used by a network to transmit the electronic currency message and an encrypted security layer;
decrypting the encrypted security layer with the middleware to retrieve a transaction message comprising details related to the transaction;
identifying the one or more external transaction networks involved in the transaction;
connecting to the one or more external transaction networks using the interfaces; and
effecting the transaction.

2. The method of claim 1, wherein the electronic currency message identifies a source of the transaction, and further comprising authenticating the source with the one or more external transaction networks.

3. The method of claim 1, wherein the electronic currency message identifies a destination of the transaction, and further comprising authenticating the destination with the one or more external transaction networks.

4. The method of claim 3, further comprising checking the destination against a list of valid destinations that are authorized to engage in transactions with a sender of the electronic currency message.

5. The method of claim 3, further comprising returning a transaction token to the destination and a sender of the electronic currency message.

6. The method of claim 1, wherein the electronic currency message does not identify a destination of the transaction.

7. The method of claim 1, further comprising transmitting an instruction to display a transaction code to the sender, wherein the transaction code is dynamically generated, at least in part, by the middleware.

8. The method of claim 1, wherein the transaction is effected using a Bluetooth Low Energy (BLE) or Near Field Communications (NFC) protocol.

9. A computer-readable medium storing computer-executable instructions that, when executed by a processor, cause the processor to:
collect credentials from a mobile device;
collect credentials relating to a user of the mobile device;
use the collected credentials to establish a creditworthiness of the user;
create a credit structure comprising a representation of the creditworthiness of the user;
store the credit structure in a cache;
receive a request to effect a transaction from the mobile device;
identify that the mobile device has lost power or connectivity;
query the credit structure stored in the cache to determine whether the user has sufficient credit to effect the transaction; and
effecting the transaction when it is determined that the user has sufficient credit.

10. The medium of claim 9, wherein the cache is a local cache on the mobile device.

11. The medium of claim 10, wherein the mobile device effects the transaction by consulting the credit structure stored in the local cache.

12. The medium of claim 9, wherein the creditworthiness of the user is established, at least in part, based on the user's usage habits with respect to the mobile device.

13. The medium of claim 9, wherein the creditworthiness of the user is established, at least in part, based on visitor location register (VLR) data obtained from the mobile device.

14. The medium of claim 9, further storing instructions for:
determining that the mobile device is likely to imminently lose connectivity or power; and
uploading the credit structure to middleware remote from the mobile device, wherein the cache is created at the middleware.

15. The medium of claim 9, wherein the request to effect the transaction is received at the middleware, and the middleware queries the credit structure.

16. The medium of claim 9, wherein the transaction is effected by the middleware.

17. A system comprising:
a push-to-pay entity; and
a processor programmed with instructions that, when executed by the processor, cause the processor to:
receive a request to effect a transaction from the push-to-pay entity;
collect information identifying the system, a user of the system, and the transaction;
create a transaction message comprising the information identifying the system, the user of the system, and the transaction;
encrypt the transaction message in an encrypted security layer;
wrap the encrypted security layer in an external package layer to create an electronic currency message, wherein the external package layer is visible to a network;
transmit the electronic currency message via the network to middleware interfaced with one or more external transaction networks involved in the transaction;
receive an instruction to effect the transaction from the middleware; and
effect the transaction.

18. The system of claim 17, wherein the push-to-pay entity is a hardware button on a mobile device.

19. The system of claim 17, wherein effecting the transaction comprises transmitting a transaction code to a destination of the transaction.

20. The system of claim 17, wherein the transaction is effected via a Bluetooth Low Energy (BLE) or Near Field Communications (NFC) protocol.
